(19) United States
(12) Patent Application Publication
(10) Pub. No.: US 2005/0280593 A1
(43) Pub. Date: Dec. 22, 2005

(54) Satellite tracking antenna and method using rotation of a subreflector

(76) Inventors: Seung-Hyeon Cha, Gunpo (KR); Jong-Hwan Cha, Ansan (KR); Kwang-Sik Eom, Anyang (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/873,708

(22) Filed: Jun. 22, 2004

(51) Int. Cl. H01Q 3/00

(52) U.S. Cl. 343/757; 343/781 P

(57) ABSTRACT

Disclosed is a satellite tracking antenna applied to a satellite tracking antenna system mounted on a vehicle and method using rotation of a subreflector. The antenna includes a reflector controlled to be oriented toward a target satellite, a subreflector for reflecting a signal reflected from the reflector to an entrance end and for identifying relative signals of upper, lower, left, and right sides of the satellite, a subreflector rotating part for rotating the subreflector at a high RPM, a driving device for driving the reflector in at least one of elevation and azimuth directions, and a fixing member for fixing the antenna system on the vehicle. Thus, since the tracking mechanism is realized by operating the elevation and azimuth motors only using the subreflector, the structure of the antenna can be simplified and the satellite tracking is accurately performed.

### BACKGROUND OF THE INVENTION

1. Field of the Invention

The present invention relates to a satellite tracking antenna mounted on a vehicle, and more particularly, to a satellite tracking antenna and method that can track a satellite using the rotation of a subreflector without using sensors.

2. Description of the Related Art

Generally, since a satellite communication is realized by a radio wave with high frequency of a micro-frequency band, a high directional antenna such as a parabolic antenna having a reflector is required to meet an intensive straight-advancing property of the radio wave. Particularly, for a directional antenna mounted on a vehicle such as a motorcar, a ship, and an airplane, there is a need for a function for tracking the satellite in response to a movement of the vehicle.

Tracking algorithms for the satellite communication can be classified into a closed loop method and an open loop method. The closed loop methods can be further classified into a lobbing method and a mono-pulse method. The closed loop method is designed to control the antenna in a predicted orbit direction by processing satellite orbit forecasting data, standard time data, and antenna digital angle data using a computer. Therefore, the tracking performance of the antenna depends on the accuracy of the data. The lobbing method is designed to control an orientation of the antenna by detecting a coming direction of a bicorn wave by moving a beam of the antenna using a predetermined method. The mono-pulse method is designed to detect an azimuth error on occasion in accordance with a radio wave with a single pulse in a state where the beam of the antenna is fixed.

The lobbing methods are further classified into a conical scanning method, a beam switching method, and a step tracking method. The conical scanning method is designed to rotate a beam of the antenna in a conical-shape having a minute angle to perform a closed tracking. The beam switching method is designed to determine a relative receiving signal level while discretely moving the beam to more than four predetermined locations disposed around an axis of the antenna. The step tracking method is designed to move the beam in a direction where the receiving level is increased by checking the variation of the receiving level while moving the antenna by a minute angle in a step manner at a predetermined time interval.

FIG. 1 shows a schematic diagram illustrating a conventional satellite tracking antenna mounted on a vehicle such as a ship.

Referring to FIG. 1, the conventional satellite tracking antenna includes a reflector 100, a subreflector 101, a first angle velocity detecting sensor 102 for detecting a movement of the vehicle in an elevation direction, an elevation motor 104 for generating rotational force, an elevation rotating pulley 103 for vertically moving the reflector 100 using the rotational force of the elevation motor 104, an antenna support 112, a second angle velocity detecting sensor 105 for detecting a movement of the vehicle in an azimuth direction, an azimuth motor 106 for generating rotational force, an azimuth rotating pulley 108 for horizontally moving the reflector 100 using the rotational force of the azimuth motor 106, and a base 109.

The base 109 of the antenna is fixed on a vehicle body, and the reflector 100 is oriented to face the satellite. The azimuth motor 106 for tracking the azimuth of the antenna and the antenna support 112 for supporting the antenna are disposed on the base 109. The azimuth rotating pulley 108 for horizontally moving the reflector 100 in accordance with the rotation of the azimuth motor 106 is installed on a lower end of the support 112, while the elevation rotating pulley 103 for vertically moving the reflector 100 in accordance with the rotation of the elevation motor 104 is installed on an upper end of the support 112. Accordingly, the reflector 100 is designed to move in the elevation and azimuth directions in accordance with the rotations of the elevation and azimuth rotating motors 104 and 106, respectively.

A radio signal from the satellite is concentrated toward the subreflector 101 by the reflector 100 and is then reflected on the subreflector 101. The reflected radio signal is transmitted to a satellite signal receiver 120 through a feed horn 113. When the vehicle moves, the movement in the elevation direction is detected by the first angle velocity detecting sensor 102, and the movement in the azimuth direction is detected by the second angle velocity detecting sensor 105. When it is detected by the sensors 102 and 105 that the orientation of the reflector 100 deviates from the target satellite, a controller 130 calculates correction values and controls the elevation and azimuth motors 104 and 106 in response to the correction values to rotate the elevation and azimuth rotating pulleys 103 and 108 by the correction values, thereby controlling the reflector 100 to be directed toward the satellite.

FIG. 2 shows a block diagram illustrating a satellite tracking algorithm of the conventional satellite tracking antenna.

Referring to FIG. 2, a satellite position correcting signal is generated by receiving a satellite signal through a dithering process 201 in a Ts1 cycle (202). An angle velocity correcting signal is generated by receiving an angle velocity signal from a gyro sensor 211 in a Ts2 cycle (212). A level correcting signal is generated 214 by receiving a sensor signal from a level sensor 213 in a Ts3 cycle (214). The correcting signals are put together and transmitted to a position controller 203. The motor 204 is driven by the position controller 203 in response to the correcting signals to control the orientation of the antenna. As described above, in the conventional satellite algorithm, the satellite position correction and the posture control are essentially required.

However, the conventional satellite tracking antenna requires two angle velocity sensors to detect the movement of the vehicle as well as two motors to rotate the antenna in response to the detected value. Therefore, the structure of the antenna and the control mechanism are complicated. Furthermore, additional hardware and software are required to initiate the sensors and to compensate for the reference value.

### SUMMARY OF THE INVENTION

Accordingly, the present invention is directed to a satellite tracking antenna and method using rotation of a subreflector that substantially obviate one or more problems due to limitations and disadvantages of the related art.

A first object of the present invention is to provide a satellite tracking antenna that can be designed in a simple structure and can provide an accurate satellite tracking performance by rotating a subreflector using only a satellite signal without using sensors.

A second object of the present invention is to provide a satellite tracking method using such an antenna.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the drawings.

To achieve these objects and other advantages and in accordance with the purpose of the invention, as embodied and broadly described herein, there is provided a satellite tracking antenna applied to a satellite tracking antenna system mounted on a vehicle, comprising: a reflector controlled to be oriented toward a target satellite; a subreflector for reflecting a signal reflected from the reflector to an entrance end and for identifying relative signals of upper, lower, left, and right sides of the satellite; a subreflector rotating part for rotating the subreflector at a high RPM; driving means for driving the reflector in at least one of elevation and azimuth directions; and fixing means for fixing the antenna on the vehicle.

In another aspect of the present invention, there is provided a method for tracking a target satellite using an antenna mounted on a vehicle, the method comprising: the steps of searching a target satellite in a state where a tracking function of the antenna is turned off; receiving position signals from a subreflector and satellite signals corresponding to the position signals in a state where the tracking function of the antenna is turned on when the target satellite is searched; generating a position correcting signal by comparing the satellite signals transmitted to corresponding positions and calculating a difference between the satellite signals; and tracking the target satellite by correcting an orientation of the antenna in response to the position correcting signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a conventional satellite tracking antenna mounted on a vehicle;

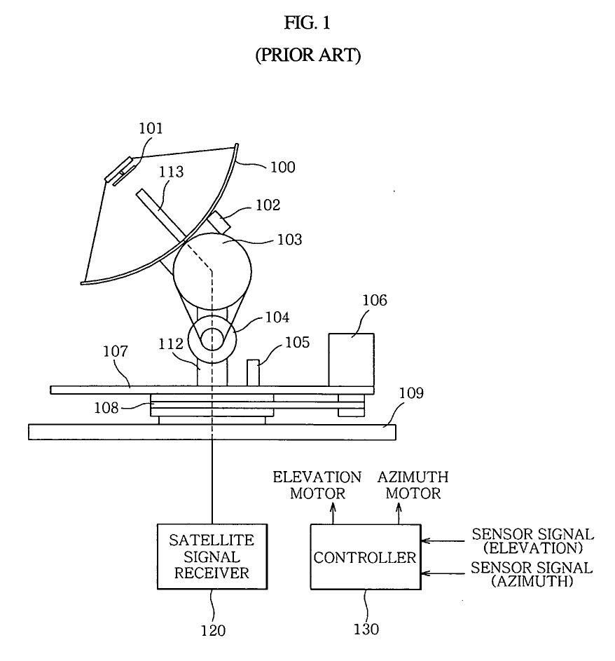

FIG. 2 is a block diagram illustrating a conventional satellite tracking algorithm;

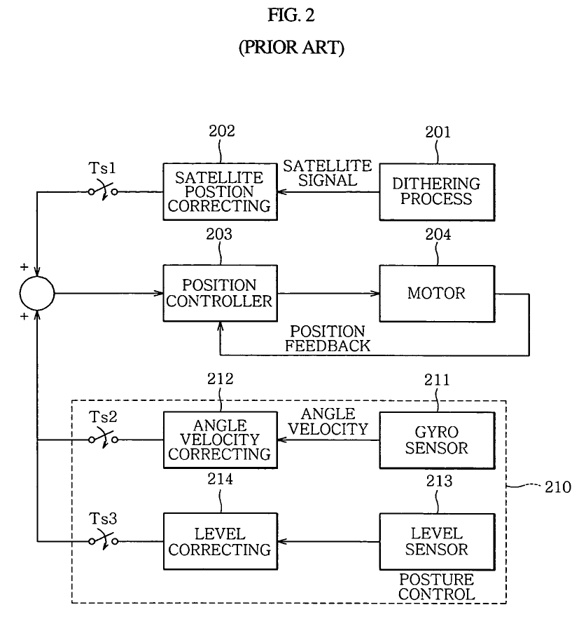

FIG. 3 is a schematic view of a satellite tracking antenna according to an embodiment of the present invention;

FIGS. 4a and 4b are schematic views illustrating a mounting concept of a subreflector depicted in FIG. 3;

FIGS. 5a and 5b are schematic views illustrating a concept of deflection caused by the rotation of a subreflector;

FIG. 6 is a schematic view illustrating a satellite tracking algorithm according to the present invention;

FIG. 7 is a flowchart illustrating a satellite tracking process according to the present invention; and

FIGS. 8a, 8b and 8c are schematic views illustrating a variety of modified examples of a subreflector depicted in FIG. 3.

### DESCRIPTION OF THE PREFERRED EMBODIMENTS

Reference will now be made in detail to the preferred embodiments of the present invention, examples of which are illustrated in the accompanying drawings.

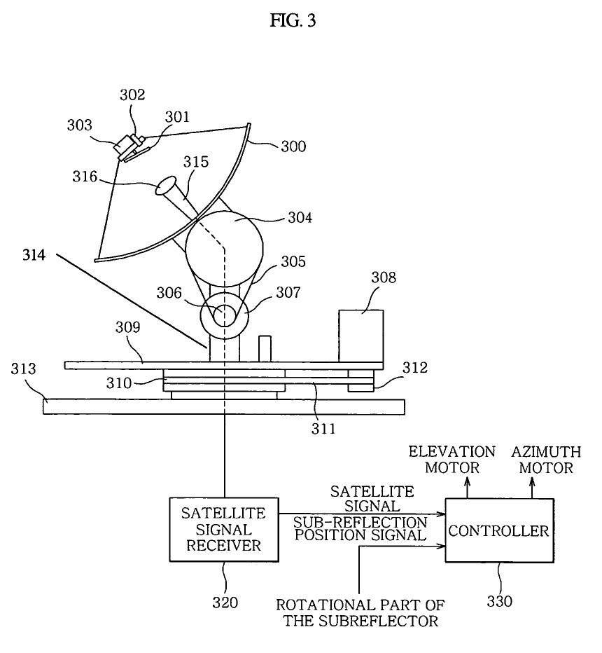

FIG. 3 shows a satellite tracking antenna according to the present invention. The satellite tracking antenna includes an antenna system mounted on an outer body of vehicle body and a satellite signal receiving/transmitting device 320 and an antenna position controller (tracker) 330 that are installed in a control room (communication room) of the vehicle.

Referring to FIG. 3, the antenna system is coupled on the outer body of vehicle by a base 313. A reflector 300 is supported by a support 314 fixed on a rotational plate 309. The reflector 300 is designed to vertically move in response to rotation of an elevation motor 307 and to horizontally move in response to rotation of an azimuth motor 308. That is, when the elevation motor 307 rotates by a control signal, an elevation driving pulley 306 rotates to rotate a driven pulley 304 by a belt 305, thereby vertically moving the reflector 300. When the azimuth motor 308 rotates by a control signal, an azimuth driving pulley 312 rotates to rotate a driven pulley 310 by a belt 311, thereby horizontally moving the reflector 300. By this operation, the rotational plate 309 rotates to vary the orientation of the antenna vertically and horizontally.

Meanwhile, a subreflector 301 is disposed facing the reflector 300 and rotates at a relatively high RPM by a rotational motor 303. Accordingly, a signal reflected from the oval-shaped reflector 300 is concentrated on the subreflector 301 and reflected thereon. The reflected signal is transmitted to the feed horn 315 and is then further transmitted to the satellite signal receiving/transmitting device 320 through a coaxial cable. At this point, a dielectric lens 316 may be inserted through an end of the feed horn 315 to further sharpen a beam. A position of the subreflector is detected by a position sensor 302, and the detected signal is transmitted to the antenna position controller 330.

When comparing the inventive antenna with the conventional antenna, gyro sensors such as elevation and azimuth sensors that are used in the conventional antenna are all omitted in the inventive antenna. That is, it is noted that the structure of the inventive antenna is more simplified. In addition, the subreflector 301 of the present invention is inclined at a predetermined angle.

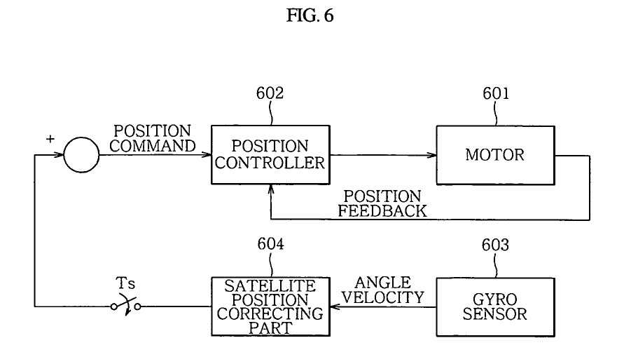

A position sensor 302 attached on a rotational part of the subreflector 301 is provided to accurately detect an inclined direction of the subreflector 301. In addition, the position sensor 302 further detects a rotation cycle of the subreflector 301 to create a Ts cycle illustrated in FIG. 6, thereby determining a sampling cycle of a controller.

The position controller 330 receives a satellite signal from the satellite signal receiving/transmitting device 320 as well as a sub-reflection position signal from the position sensor 302 to control the elevation and azimuth motors 307 and 308, thereby controlling the orientation of the antenna toward a target satellite. At this point, the satellite signal receiving/transmitting device 320 includes an information analyzing part for analyzing a data signal transmitted from the satellite and determining if a satellite toward which the antenna is currently directed is the target satellite.

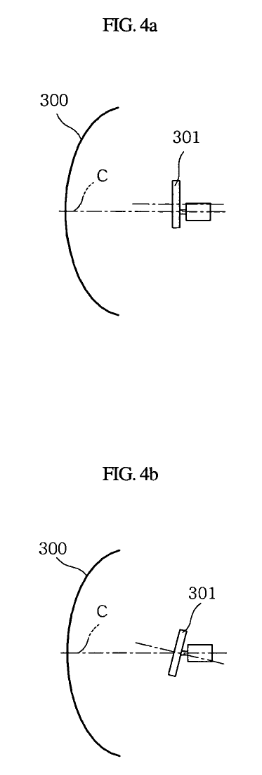

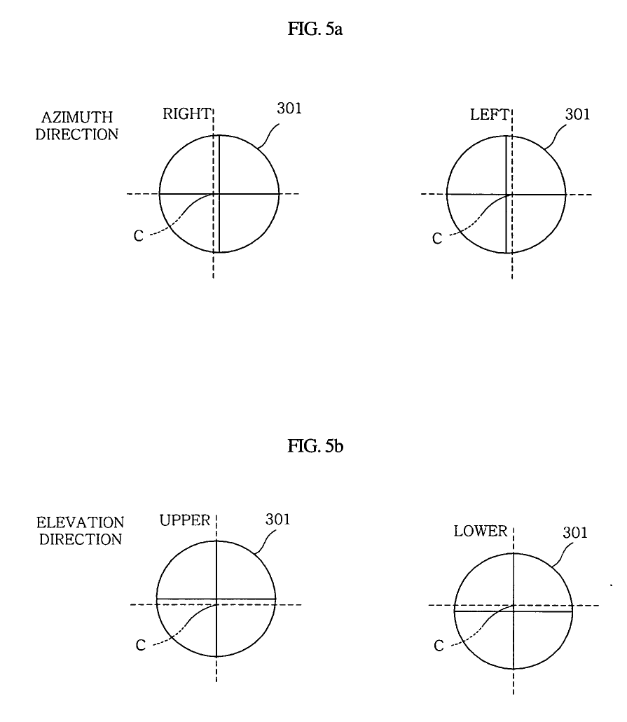

FIGS. 4a and 4b show a subreflector installing concept and FIGS. 5a and 5b show a concept of deflection caused by the rotation of the subreflector.

Specifically, FIG. 4a shows a state where a central axis of the subreflector 301 is deviated from a central axis C of the reflector 300, and FIG. 4b shows a state where the subreflector 301 is rotated in a state where it is inclined with respect to the central axis C of the reflector 300 at a predetermined angle.

These two states are all possible in the present invention, realizing an identical performance. At this point, vertical and horizontal positions of the subreflector 301 are determined using the position sensor 302.

FIGS. 5a and 5b show states where the subreflector 301 installed as in FIG. 4a or 4b is deflected by rotation. That is, FIG. 5a shows a state where the subreflector 301 is deflected in a horizontal direction, and FIG. 5b shows a state were the subreflector 301 is deflected in a vertical direction.

When the subreflector 301 is inclined with respect to the central axis C of the reflector 300 to accurately track the target satellite (i.e., when the orientation of the reflector is accurately directed to the target satellite), satellite signals coming to upper, lower, left and right sides have identical signal intensity and are all identical to each other. However, when the subreflector 301 is deflected to a side, the intensity of a signal transmitted to the deflected side is greater than those of others. That is, when the orientation of the reflector 300 is deflected to the right side with respect to the target satellite, the intensity of a receiving signal obtained when the subreflector 301 is deflected to the right side will be greater than that obtained when the subreflector 301 is deflected to the left side. When the orientation of the reflector 300 is inclined to the upper side, a receiving signal obtained when the subreflector 301 is deflected to the upper side will be greater than that obtained when the subreflector 301 is deflected to the lower side.

Accordingly, it will be identified which direction the orientation of the antenna is deviated with respect to the target satellite by comparing the receiving signals obtained when the subreflector 301 is deviated to the upper, lower, right and left sides. That is, an intensity difference between the receiving signals is scaled and a position correcting signal is generated by a scaled value. The corresponding motor is driven in response to the position correcting signal so as for the orientation of the antenna to be directed to track the target satellite.

Next, the satellite tracking process according to the present invention will be described hereinafter.

Again referring to FIG. 3, the reflector 300 is a part for receiving a satellite signal. The satellite signal directed to the reflector 300 is transmitted through the subreflector 301. Since the subreflector rotates in a state where it is inclined with respect to its rotational axis, the maximum signal value is lowered, but it provides information on the satellite direction where the reflector 300 should move and an amount of movement of the reflector.

For example, when the inclined surface of the subreflector 301 faces the upper side of the reflector 300, the intensity of the signal transmitted to the upper side of the reflector 300 becomes greater than others. When it faces the lower side of the reflector 300, the intensity of the signal transmitted to the lower side of the reflector 300 becomes greater than others. Therefore, when it is determined that the signals transmitted to the upper and lower sides are identical, it should be noted that the orientation of the antenna is correctly directed toward the satellite with regard to the vertical direction. When the signal transmitted to the upper side is greater than that transmitted to the lower side, the elevation motor 307 is rotated in an upper direction to correct the position of the reflector 300 by rotating the driven pulley 304 through the elevation driving pulley 306. When the signal transmitted to the lower side is greater than that transmitted to the upper side, the elevation motor 307 is rotated in a lower direction to correct the position of the reflector 300 by rotating the driven pulley 304 through the elevation driving pulley 306. At this point, the driving amount of the elevation motor 307 is determined in proportion to the intensity difference between the signals.

Likewise, when the inclined surface of the subreflector 301 faces the left side of the reflector 300, the intensity of the signal transmitted to the left side of the reflector 300 becomes greater than others. When it faces the right side of the reflector 300, the intensity of the signal transmitted to the right side of the reflector 300 becomes greater than others. Therefore, when it is determined that the signals transmitted to the left and right lower sides are identical, it should be noted that the orientation of the antenna is correctly directed toward the satellite with regard to a horizontal direction. When the signal transmitted to the left side is greater than that transmitted to the right side, the azimuth motor 308 is rotated in a left direction to correct the position of the reflector 300 by rotating the driven pulley 310 through the azimuth driving pulley 312. When the signal transmitted to the right side is greater than that transmitted to the left side, the azimuth motor 308 is rotated in a right direction to correct the position of the reflector 300 by rotating the driven pulley 310 through the azimuth driving pulley 312. At this point, the driving amount of the azimuth motor 308 is determined in proportion to the intensity difference between the signals.

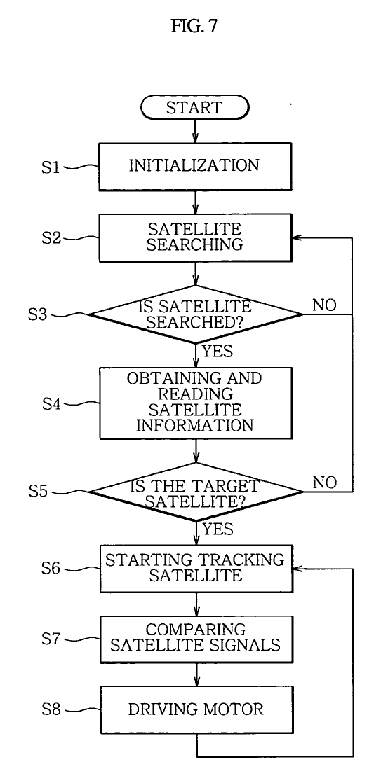

FIG. 6 shows a satellite tracking algorithm according to the present invention, and FIG. 7 shows a flowchart illustrating a satellite tracking process according to the present invention.

Referring first to FIG. 6, a satellite position correcting part 604 generates a position correcting signal by (a) receiving a rotational position signal of the subreflector 301 from a subreflector rotating part 603 and satellite signals at each side, (b) comparing the satellite signals, and (c) calculating a signal difference between the satellite signals. At this point, the rotation time Ts of the subreflector 301 becomes a cycle for generating a position command. The position correcting signal is transmitted to a position controller 602 in a Ts cycle, and the position controller 602 controls a corresponding motor 601 in response to the position correcting signal to track the satellite. At this point, different from the conventional dithering method, the position correcting cycle Ts is fast enough to track the satellite in real-time. Therefore, the satellite tracking can be quickly realized even without using an angle velocity sensor and a level sensor.

Referring to FIG. 7, an initialization is performed after the antenna is operated (S1), and the satellite searching is processed (S2). When the satellite is searched (S3), it is identified if the searched satellite is a target satellite by obtaining satellite information and reading the information (S4 and S5). When it is determined that the searched satellite is not the target satellite, the above steps (S2-S5) are repeated until the target satellite is searched. When it is determined that the searched satellite is the target satellite, a tracking operation is started (S6), after which a position signal of the subreflector and satellite signals are inputted and the satellite signals are compared with each other (S7). When it is identified by the comparison that the intensities of the signals are identical to each other, it is determined that the orientation of the antenna is correctly directed toward the target satellite. When it is identified by the comparison that there is an intensity difference between the signals, a correcting signal corresponding to the intensity difference is generated and the motor is driven in response to the correcting signal so as for the orientation of the reflector of the antenna to be directed toward the target satellite (S8).

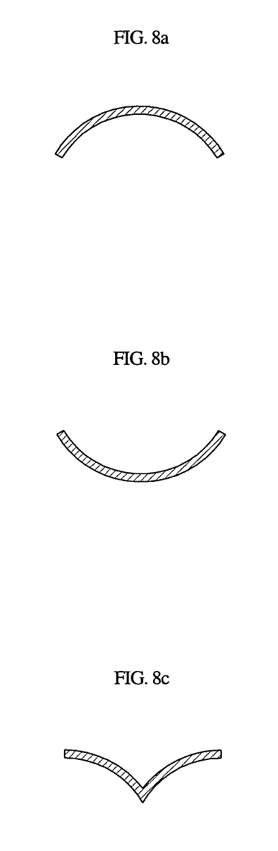

FIGS. 8a, 8b, and 8c show a variety of modified examples of the subreflector.

In the above-described embodiment, the subreflector 301 is formed in a flat type. However, the present invention is not limited to this. That is, the subreflector 301 may be formed in a concave type (see FIG. 8a), a convex type (see FIG. 8b), or a V-shape type (see FIG. 8c).

As described above, when the antenna is deviated by the movement of the vehicle in rolling, pitching, and yawing directions, the satellite signal is varied in vertical and horizontal directions. At this point, the upper and lower signals are compared with each other and the elevation motor is driven in the larger signal direction. In addition, the left and right signals are also compared with each other and the azimuth motor is driven in the larger signal direction. Accordingly, the orientation of the antenna is controlled toward the satellite. In addition, by analyzing the satellite data, it can be identified if a searched satellite is a target satellite. As described above, since the tracking mechanism is realized using the elevation and azimuth motors without using a variety of sensors attached on the vehicle, the structure of the antenna can be simplified and the satellite tracking is accurately performed.

It will be apparent to those skilled in the art that various modifications and variations can be made in the present invention. Thus, it is intended that the present invention covers the modifications and variations of this invention provided they come within the scope of the appended claims and their equivalents.

1. A satellite tracking antenna applied to a satellite tracking antenna system mounted on a vehicle, comprising:
a reflector controlled to be oriented toward a target satellite;
a subreflector for reflecting a signal reflected from the reflector to an entrance end and for identifying relative signals of upper, lower, left, and right sides of the satellite;
a subreflector rotating part for rotating the subreflector at high rotations per minute (RPM);
driving means for driving the reflector in at least one of elevation and azimuth directions; and
fixing means for fixing the antenna system on the vehicle.

2. The satellite tracking antenna of claim 1, wherein the subreflector is inclined with respect to a central axis of the reflector at a predetermined angle.

3. The satellite tracking antenna of claim 1, wherein the subreflector is installed such that a central axis of the subreflector is deviated from a central axis of the reflector.

4. The satellite tracking antenna of claim 1, wherein the subreflector rotating part comprises a position sensor for detecting upper, lower, left, and right position signals of the subreflector.

5. The satellite tracking antenna of claim 4, further comprising a controller for (a) receiving the upper, lower, left, and right position signals from the position sensor of the subreflector, (b) receiving satellite signals through the entrance end, (c) comparing intensities of the satellite signals corresponding to the upper, lower, left and right position signals, and (d) controlling the driving means in response to a comparison result to track the satellite.

6. The satellite tracking antenna of claim 1, further comprising a satellite information analyzing part for (a) analyzing a data signal transmitted from the satellite and (b) determining if a currently-directing satellite is a target satellite.

7. The satellite tracking antenna of claim 1, wherein the subreflector is formed in a type including one of a flat type, a convex type, a concave type, and a V-shape type.

8. The satellite tracking antenna of claim 1, further comprising a feed horn provided at an end with a dielectric lens to sharpen a beam shape.

9. A method for tracking a target satellite using an antenna mounted on a vehicle, the method comprising the steps of:
searching a target satellite in a state where a tracking function of the antenna is turned off;
receiving position signals from a subreflector and satellite signals corresponding to the position signals in a state where the tracking function of the antenna is turned on when the target satellite is searched;
generating a position correcting signal by comparing the satellite signals transmitted to corresponding positions and calculating a difference between the satellite signals; and
tracking the target satellite by correcting an orientation of the antenna in response to the position correcting signal.

10. The method of claim 9, wherein the upper, lower, left, and right position signals represent deflected positions of the subreflector to upper, lower, left, and right sides, and the satellite signals are transmitted to the corresponding upper, lower, left, and right sides;
the satellite signal of the upper side is compared with the satellite signal of the lower side to correct an elevation direction; and
the satellite signal of the left side is compared with the satellite signal of the right side to correct an azimuth direction.

11. The method of claim 10, wherein the position correcting signal is generated by scaling a difference between the corresponding satellite signals to a predetermined value.
